(19) United States
(12) Patent Application Publication
(10) Pub. No.: US 2015/0365767 A1
(43) Pub. Date: Dec. 17, 2015

(54) VOICE COIL AND MICRO-SPEAKER USING SAME

(71) Applicant: Changliang Wang, Shenzhen (CN)

(72) Inventor: Changliang Wang, Shenzhen (CN)

(73) Assignee: AAC Technologies Pte. Ltd., Singapore city (SG)

(21) Appl. No.: 14/551,529

(22) Filed: Nov. 24, 2014

(30) Foreign Application Priority Data
Jun. 16, 2014 (CN) 201420321545.8

(51) Int. Cl. H04R 9/02

(52) U.S. Cl. CPC H04R 9/02; H04R 9/025

(57) ABSTRACT

A voice coil and a micro-speaker using the same are disclosed in present disclosure. The voice coil includes a base body vibrating in a vibration direction; a pair of lead wires associated with the base body, each of the lead wires including a first connecting portion, a second connecting portion and a connecting coil connected between the first and second connecting portions, the connecting coil formed in a helix structure with an axis thereof parallel to the vibrating direction.

### FIELD OF THE INVENTION

The present invention relates to a speaker apparatus, and more particularly, to a micro-speaker including a voice coil having improved mechanical property.

### DESCRIPTION OF RELATED ART

With the rapid development of wireless communication technologies, portable electronic devices are widely used. Users require portable electronic devices to not only have voice function, but also have high quality acoustic performance. A portable electronic device also provides the users with entertainment contents, such as music, video, game, and so on. For converting electrical signals into audible sounds, a speaker is a necessary component used in the portable electronic device for generating sounds. With the portable electronic device, such as a mobile phone, designed to be smaller and smaller, the speaker used therein is also required to have a low profile with small size.

A micro-speaker related to the present art includes a frame, a magnet circuit unit received in the frame and an vibration unit facing the magnet circuit unit and fixed to the frame. The vibration unit includes a voice coil with lead wires suspended in the frame and a diaphragm coupled to the voice coil. The lead wires are U-shaped with a limited horizontal width, which can increase the equivalent plastic strain of the lead wire and thus decrease the serving life of the lead wire. In the present art, the equivalent plastic strain of the lead wire can be reduced by increasing the horizontal width of the U-shaped lead wire. In such case, the frame needs to become bigger and bigger for supplying sufficient space to accommodate the lead wire. Thus, the speaker with such frame cannot meet the requirement that the speaker is required to have a low profile with small size.

Therefore, an improved voice coil which can overcome the disadvantages described above is desired.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric exploded view of a micro-speaker in accordance with an exemplary embodiment of the present disclosure.

FIG. 2 is an isometric view of a voice coil of the micro-speaker shown in FIG. 1.

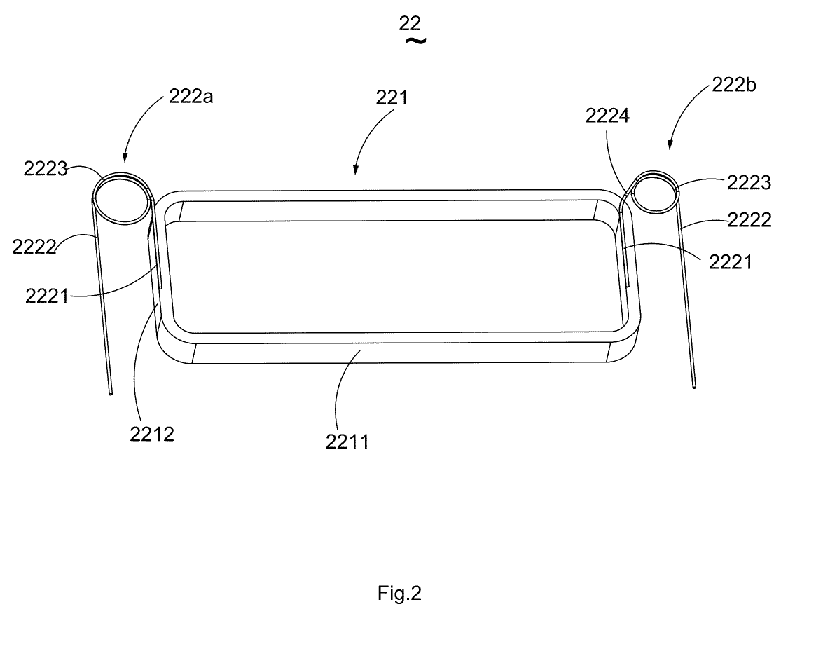

### DETAILED DESCRIPTION OF THE EXEMPLARY EMBODIMENT

The present invention will hereinafter be described in detail with reference to an exemplary embodiment.

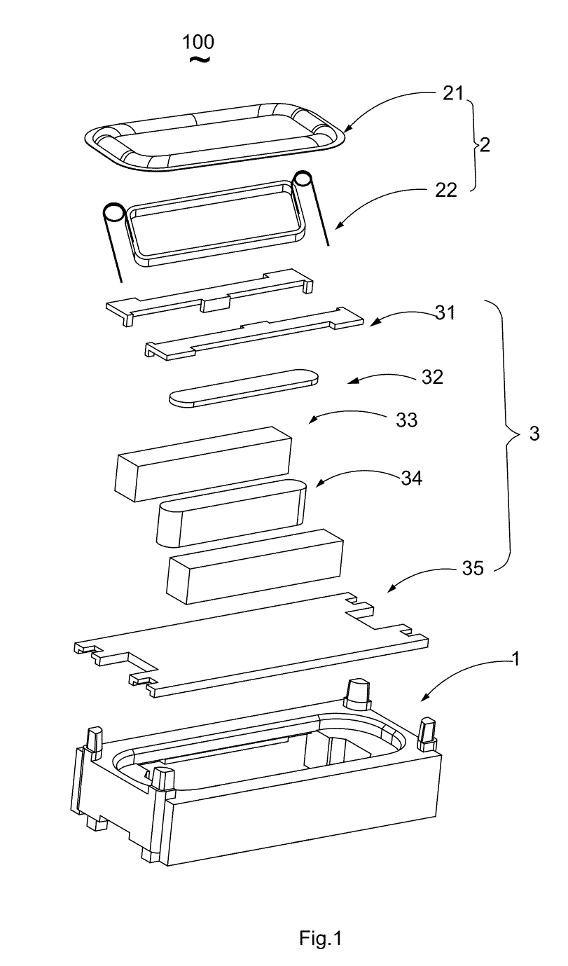

Referring to FIG. 1, a micro-speaker 100 according to the present disclosure comprises a frame 1, a magnetic circuit unit 3 received in the frame 1, and an vibration unit 2 facing the magnetic circuit unit 3 and fixed to the frame 1.

The magnetic circuit unit 3 comprises a lower plate 35 fixed to the frame 1, a main magnet 34 positioned on a central portion of the lower plate 35, a pair of auxiliary magnets 33 mounted on two side portions of the lower plate 35 and positioned spaced from the main magnet 34 for forming a magnetic gap, a pole plate 32 attached to a top surface of the main magnet 34, and a pair of upper plates 31 attached to the top surfaces of the auxiliary magnets 33 respectively. The magnetic circuit unit 3 can be formed in any other structure, such as that includes a yoke and a single magnet received in the yoke.

The vibration unit 2 includes a voice coil 22 suspended in the magnetic gap and a diaphragm 21 coupled to the voice coil 22 with a periphery of the diaphragm 21 fixed to the frame 1. The diaphragm 21 is made of stretchable and soft material.

When electrified, the voice coil 22 is driven to vibrate in a vibration direction by the alternating Lorenz Force generated by the magnetic field in the magnetic gap. The movement of the voice coil 22 activates the diaphragm 21 to vibrate, thereby producing sounds.

Note that the micro-speaker may be susceptible to various modifications and alternative forms. Thus, the number of diaphragms, magnets, voice coils, pole pieces, and so on, may differ.

In this embodiment, the voice coil 22 includes a base body 221 and a pair of lead wires 222 associated therewith. The base body 221 is formed by winding an electrically conductive wire around a central axis parallel to the vibration direction. The electrically conductive wire may be formed by a variety of types of wire, such a Cu wire or a Copper Clad Aluminum (CCA) wire. Optionally, the lead wires 222a, 222b may be constituted by the same conductive wire forming the base body 221.

Specifically, the base body 221 is a hollow ring, and includes a pair of first sides 2211 opposite to each other and a pair of second sides 2212 opposite to each other. The first sides 2211 and the second sides 2212 are connected with each other to form the hollow ring. Note that the base body is implemented as an electrically conductive wire being wounded and shaped in a particular shape in order to match the shape of the magnetic gap of the magnetic circuit unit. In principle, the base body may take any shape, such as circular, rectangular and so on.

The pair of lead wires configured for connecting the base body 221 to external driving circuit serve as a lead-out wire 222a connected with an outer edge of one second side 2212 and a lead-in wire 222b connected with an inner edge of another second side 2212, respectively. Each of the lead-out and lead-in wires 222a, 222b comprises a first connecting portion 2221, a second connecting portion 2222 and a connecting coil 2223 connected between the first and second connecting portions 2221, 2222. In this embodiment, the first connecting portion 2221 is electrically connected with the base body 221; the second connecting portion 2222 is electrically connected with an external driving circuit. The first connecting portion 2221 is parallel to the second connecting portion 2222, both of which take straight line shape.

The connecting coil 2223 is formed as an integral part of corresponding lead wire, such as the lead-out wire or lead-in wire. Optionally, a series connection involving the base body, lead wire and connecting coil is established using a single and unbroken wire. In this embodiment, the connecting coil 2223 is formed by wrapping the electrically conductive wire around an axis parallel to the vibration direction in a helix manner, i.e. the connecting coil 2223 takes a helix structure with an axis thereof parallel to the vibration direction. The connecting coil 2223 typically contains 2-5 windings and extends away from the diaphragm 21. With the construction of the lead wire with such a connecting coil, the equivalent plastic strain of the lead wire reduces without increasing the horizontal width of the lead wire, since the connecting coil extends away from the diaphragm in the vibration direction.

In this embodiment, the lead-in wire 222b further includes a third connecting portion 2224 extending from the first connecting portion 2221 to the connecting coil 2223 for improving the structure strength of the lead-in wire 222b. The third connecting portion 2224 is an arc.

In the present disclosure, with the construction of the lead wire, the connecting coil formed in a helix structure with an axis parallel to the vibration direction can reduce the equivalent plastic strain of the lead wire and thus increase the serving life of the lead wire, which can be concluded from the simulation analysis result of the lead wires recited in Table 1

TABLE 1

| | Maximum equivalent | Maximum equivalent |
|---|---|---|
| Structure of | plastic strain | plastic strain |
| the lead wire | of the lead-in wire | of the lead-out wire |
| lead wire with | 0.5521 | 0.5298 |
| U-shaped | | |
| structure | | |
| lead wire with | 0.00413 | 0.3536 |
| connecting coil | | |

As shown in Table 1, the maximum equivalent plastic strain of the lead-in and lead-out wires according to the present disclosure are lower than that of the lead wire with U-shaped structure. Thus, the serving life of the lead wire increases.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A voice coil, comprising,
a base body vibrating in an vibration direction;
a pair of lead wires associated with the base body, each of the lead wires comprising a first connecting portion, a second connecting portion and a connecting coil connected between the first and second connecting portions, the connecting coil formed in a helix structure with an axis thereof parallel to the vibrating direction.

2. The voice coil according to claim 1, wherein the first connecting portion is parallel to the second connecting portion.

3. The voice coil according to claim 1, wherein the connecting coil is formed as an integral part of corresponding lead wire.

4. The voice coil according to claim 3, wherein,
the base body is a hollow ring including a pair of sides opposite to each other;
the pair of lead wires serve as a lead-out wire connected with an inner edge of one side and a lead-in wire connected with an outer edge of another side, respectively.

5. The voice coil according to claim 4, wherein the lead-in wire further comprises a third connecting portion extending from the first connecting portion to the connecting coil.

6. The voice coil according to claim 5, wherein the third connecting portion is an arc.

7. A micro-speaker, comprising:
a frame;
a magnetic circuit unit received in the frame;
an vibration unit facing the magnetic circuit unit and fixed to the frame, the vibration unit including a diaphragm and a voice coil driving the diaphragm, the voice coil including a base body vibrating in a vibrating direction and a pair of lead wires associated with the base body, each of the lead wires including a first connecting portion, a second connecting portion and a connecting coil connected between the first and second connecting portions, the connecting coil formed in a helix structure with an axis thereof parallel to the vibrating direction.

8. The micro-speaker according to claim 7, wherein the first connecting portion is parallel to the second connecting portion.

9. The micro-speaker according to claim 7, wherein the connecting coil is formed as an integral part of corresponding lead wire.

10. The micro-speaker according to claim 9, wherein,
the base body is a hollow ring including a pair of sides opposite to each other;
the pair of lead wires serve as a lead-out wire connected with an inner edge of one side and a lead-in wire connected with an outer edge of another side, respectively.

11. The micro-speaker according to claim 10, wherein the lead-in wire further comprises a third connecting portion extending from the first connecting portion to the connecting coil.

12. The micro-speaker according to claim 11, wherein the third connecting portion is an arc.
